(19) United States
(12) Patent Application Publication
(10) Pub. No.: US 2009/0300505 A1
(43) Pub. Date: Dec. 3, 2009

(54) INFORMATION PROCESSING APPARATUS, RECOVERING METHOD OF ENTRY INFORMATION THERETO, AND RECORDING MEDIUM

(75) Inventor: Tatsuya KITA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/362,096

(22) Filed: Jan. 29, 2009

(30) Foreign Application Priority Data
May 30, 2008 (JP) 2008-143843

(51) Int. Cl. G06F 3/048

(52) U.S. Cl. 715/736; 715/780

(57) ABSTRACT

An information processing apparatus (web system) connected to a network to transmit and receive information is configured to monitor an entry into an information entry field (html or web page) provided from a network, to store the entry contents into a storage means (recording system) along with identification information, and to import the entry contents from the storage means for recovery on the information processing apparatus based on an entry content recovery instruction when the entry contents are lost.

### CROSS-REFERENCE TO RELATED APPLICATIONS

This application is based upon and claims the benefit of priority from the prior Japanese Patent Application No. 2008-143843, filed on May 30, 2008, the entire contents of which are incorporated herein by reference.

### FIELD

A certain aspect of the embodiments discussed herein relates generally to protection and recovery of entry contents in, for example, a web (World Wide Web) browser that is an information sharing system over the Internet, and, more particularly, to an information processing apparatus recovering entry contents lost in the information processing apparatus, a recovering method of entry information thereof, and a recording medium.

### BACKGROUND

The dissemination of the Internet acts as a convenience infrastructure that enables merchandising mediated by the Internet and procedural processes such as delivery of documents over the web. The procedures on the web widely range from simple procedures such as entering brief personal information to those associated with a long text such as inquiry for product information, guide, description of a failure part, and description of situation for a repair request. These pieces of information are normally entered through the mediation of a web browser.

In the case of mail-order over the Internet, after a “destination information entry page” is opened on a web browser and information is entered such as “name” and “address” specified in an “entry form” on the page, entries are arranged to be transmitted to an opposite server if a “transmission (or confirmation/decision)” button is clicked. In such an arrangement, contents in the middle of entry into the “entry form” are not transmitted to the opposite server before the “transmission” button is clicked. The entry contents are retained on the web browser unless the “transmission” button is clicked.

Some web browsers have functions of “going back to the previously displayed page”, “proceeding to the page before going back”, and “reloading the current page”. The “reload” function is a function of issuing a request to the opposite server for retransmission of the currently displayed page. If the “reload” function is executed during entry into the “entry form”, the opposite web server (unable to recognize that the entry is in process since the “transmission” button is not yet clicked) retunes to the web browser a page in the default state of the displayed page, i.e., with all the entry fields in blank and, therefore, the “reload” of the page is completed in the state that all the entry contents are erased on the page received by the web browser.

Although it takes less effort for reentry after the “reload” in the case of the entry to the extent of brief personal information, if “reload”, “back”, “proceed”, etc., are wrongly operated, for example, in the middle of the entry of a long text such as description of situation for a repair request, all the entry contents are erased and, therefore, it takes a lot of trouble for the reentry. If willingness to purchase merchandise is lost because of the time loss due to the reentry as well as the effort to reenter, this leads to a loss for a web site manager.

In some entry systems of web browsers, when a web browser is forcibly terminated due to failure thereof, if UI design of a web application is insufficient, error display may be generated such as “incorrect entry format” and the entry contents may be lost even if the page is backed.

In some cases, “cache inhibition” is specified by a server on a web page for entering personal information and, in this case, a browser must “reload” at the time of redisplaying, entry contents may be erased in the same way.

With regard to entry contents on a web browser, Japanese Patent Application Laid-Open Publication No. 10-307795 discloses that when it is desired to store an operation state executed on a web browser, since the web browser instructs the regeneration of a page and generates a URL including a query character string for specifying the operation state and the web browser transmits the URL to a web server and receives and displays page information returned from the web server and corresponding to the URL, if a client wants to store the page reflecting the operation state, the client may use a URL storing function formed in the web browser to store the URL expressing the page (Abstract, FIG. 1, etc.).

The web browser is designed for displaying web pages and the entry function may be thought to be an auxiliary function of the web browser. The web browser is used for entry of the “entry form” on the web site. For example, the web browser displaying web pages is used on a web page for “request for repair”, etc.

If retention and recovery of entry contents of the “entry form” displayed on web browsers depend on the implementation level of the web browsers, the entry contents may temporarily be retained as a “portion of a web page cache”. Specifically, when entry is made on the “entry form” and “transmitted” to display the next page, if a “back” operation causes a web page including the “entry form” displayed immediately before to be redisplayed, the web page is redisplayed based on the read “cache” without accessing the web site. Since the entry contents are retained as a portion of the cache in this case, the entry contents are accordingly recovered.

As above, the web browser includes a process of (1) correlating and retaining the entry contents with the cache to recover the contents at the time of redisplay of the cache or (2) recovering the entry contents by a server returning the contents embedded into html.

In such a process, the contents may be recovered not only by the browser but also by the server of the web site. Since the entry contents are stored in the web site when the entry contents are transmitted, if the above “back” operation causes the entry page to be redisplayed, the entry contents may be recovered by returning “entry forms” in html returned by the server with the (transmitted) entry contents embedded as if the contents are entered from the beginning.

It is problematic that the entry contents may not necessarily be recovered in such a process.

A) In the case of (1), since the entry contents are recorded in association with a page cache, the contents may not be recovered unless the cache is utilized. Since a button labeled as “back” on screen may use “JavaScript:history.back( ), which redisplays a cache” (JavaScript: a script language co-developed by Netscape Communications and SunSoft in the U.S.) and “<a href=XXX>, which requests and displays the immediately preceding page from a site”, and the recovery is not available in the latter case.

B) If an expiration is set for a cache of web pages, the recovery is limited by the expiration date. The cache is set disabled in some web pages to prevent information other than the latest information from being displayed due to cached contents when a web server dynamically generates and displays information and, in this case, the same state as A) is generated. This setting may automatically be specified in the browser by the server when returning a web page so as to “prevent personal information from leaking from the cache” on a page for entering personal information, etc., and this is inevitable for users.

C) In the case of (2), entry contents not transmitted will not be recovered. If entry contents are not transmitted, the server may not know the entry contents. Of course, the embedding may not be performed and the entry contents are not recovered.

D) When a “reload” operation is performed on a displayed page, the entry contents may not be recovered. The “reload” is a function of requesting the server to retransmit the displayed page. Since all the entry contents are initialized with such a function, the recovery is not available.

E) The entry contents may not be recovered in such a case that the web browser is forcibly terminated. In this case, the entry contents are not transmitted since the contents are not transmitted, and since the cache is disabled, the recovery is not available.

Therefore, one key touch error on a web page (a recent keyboard may includes dedicated buttons such as “back” and “proceed”) causes all the entry contents to be lost or an erroneous click of a link on a cache-disabled page causes loss, etc., of the entry contents. Conventionally, the recovery process after the loss of the entry contents is extremely limited; determination must be made whether an effort of the recovery process or reentry of the entry contents; and if the entry contents are long texts, the reentry thereof places too much burden on users.

In the current situation where it is difficult to handle such loss, storage, and recovery of entry contents, this situation is caused because a web page displayed over the Internet is mainly designed for information display; a web browser is a tool used mainly for utilization of the information display and attaches importance to the web-page display function centering on the imaging speed and the URL management function.

Japanese Patent Application Laid-Open Publication No. 10-307795 does not disclose or suggest the requirement and the problem as well as a configuration, etc., for resolving the requirement and the problem.

### SUMMARY

An aspect of the invention provides an information processing apparatus connected to a network to transmit/receive information, which is configured to monitor an entry into an information entry field provided from a network, to store the entry contents into a storage unit along with identification information, and to import the entry contents from the storage unit for recovery on the information processing apparatus based on an entry content recovery instruction when the entry contents are lost. For example, entry contents into an entry form are monitored and the contents are sequentially transferred and stored in the storage unit (e.g., server) in real time. The loss of the entry contents triggers the stored entry contents to be read and recovered on the information processing apparatus. Although a user recognizes the loss of the entry contents, the entry contents are recovered in the information entry field as if the entry contents were not lost.

An aspect of the invention provides an information processing apparatus, connected to a network, which transmits and receives information, including an information entering unit that displays an information entry field provided from the network to make an entry into the information entry field; an entry monitoring unit that monitors the entry into the information entry field, and that outputs entry contents of the information entry field along with at least identification information of the information entering unit; a storage unit that correlates the entry contents output from the entry monitoring unit with the identification information to store the entry contents; and an entry recovering unit that accepts a recovery instruction for the entry contents including the identification information from the information entering unit losing the entry contents, and that takes the entry contents in from the storage unit and recovers the entry contents on the information processing apparatus.

With such a configuration, since the entry into the information entry field provided from the network may be monitored; the entry contents may be stored into the storage unit along with the identification information of the entry; the recovery instruction from the information entering unit losing the entry contents may be accepted; and the entry contents may be recovered on the information processing apparatus, the entry contents may easily be conserved and recovered and a user may avoid the trouble of making a reentry.

An aspect of the invention provides an entry recovering method of an information processing apparatus, connected to a network, which transmits and receives information, including of displaying an information entry field provided from the network to make an entry into the information entry field; monitoring the entry into the information entry field to output entry contents of the information entry field along with at least identification information of the entry; correlating the entry contents with the identification information to store into a storage unit; and accepting a recovery instruction for the entry contents including the identification information to take the entry contents in from the storage unit and recover the entry contents on the information processing apparatus when the entry contents are lost.

An aspect of the invention provides a computer-readable recording medium storing an entry recovering program of an information processing apparatus connected to a network to transmit and receive information, the program operable to drive the apparatus to function as an entry monitoring unit that displays an information entry field provided from the network, the entry monitoring unit monitoring the entry into the information entry field to output entry contents of the information entry field along with at least identification information of the entry; a storage unit that stores the entry contents output from the entry monitoring unit, the storage unit correlating the entry contents with the identification information; and an entry recovering unit that accepts a recovery instruction for the entry contents including the identification information to take the entry contents in from the storage unit and recover the entry contents on the information processing apparatus when the entry contents are lost.

The advantages of the invention will be realized and attained by means of the elements and combinations particularly pointed out in the claims.

It is to be understood that both the foregoing general description and the following detailed description are exemplary and explanatory and are not restrictive of the invention, as claimed.

Other features and advantages of the embodiments of invention will become more apparent by reference to the accompanying drawings and embodiments.

### BRIEF DESCRIPTION OF DRAWINGS

FIG. 1 is a diagram of a web system according to a first embodiment;

FIG. 2 is a diagram of a process sequence of an input/output and recovery process of the web system;

FIGS. 3A to 3C are diagrams of data tables storing entry contents;

FIG. 4 is a flowchart of an entry content monitoring and recording process procedure;

FIG. 5 is a flowchart of a web page display process procedure;

FIG. 6 is a diagram of a basic configuration of a user terminal;

FIG. 7 is a diagram of a basic configuration of a server;

FIG. 8 is a flowchart of another entry content monitoring and recording process procedure;

FIG. 9 is a flowchart of another web page display process procedure;

FIG. 10 is a diagram of a web system according to a second embodiment;

FIG. 11 is a diagram of a process sequence of an entry content storing process;

FIG. 12 is a flowchart of an entry content monitoring and recording process procedure;

FIG. 13 is a flowchart of a process procedure of an entry content recovering process;

FIG. 14 is a flowchart of a process procedure of another entry content recovering process;

FIG. 15 is a diagram of a basic configuration of a user terminal;

FIG. 16 is a diagram of an exemplary configuration of a server;

FIG. 17 is a flowchart of process procedure of a webpage entry content monitoring, storing, and recovering;

FIG. 18 is a diagram of transmission contents to a recording system; and

FIG. 19 is a diagram of request contents for recovering the entry contents.

### DESCRIPTION OF EMBODIMENTS

### [a] First Embodiment

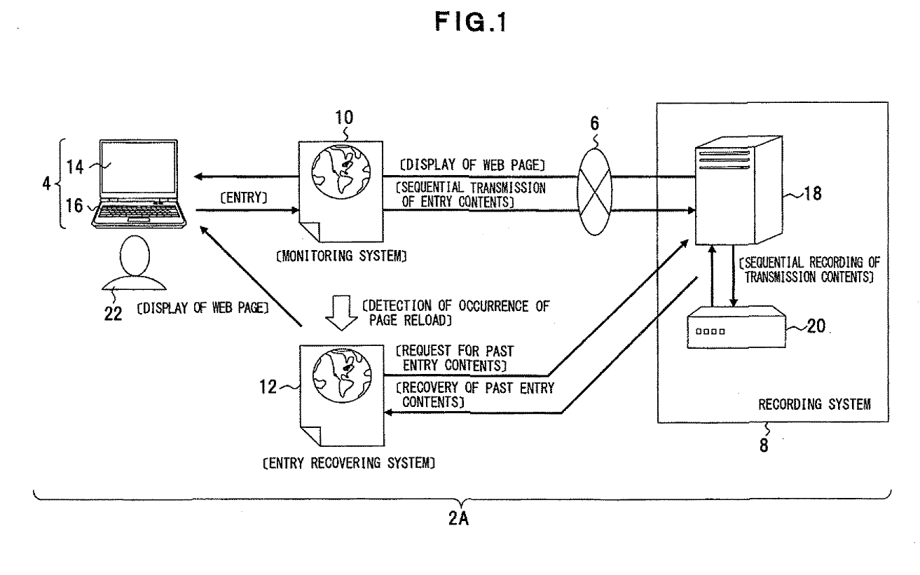

A first embodiment will be described with reference to FIG. 1. FIG. 1 is a diagram of a web system according to the first embodiment. The configuration depicted in FIG. 1 is by way of example and the present invention is not limited to this configuration.

A web system 2A is an example of an information processing apparatus and recovering method and program of entered information thereof, and is an example of a system for sharing information over a network such as the Internet. As depicted in FIG. 1, the web system 2A is a system connecting a user terminal 4 to a recording system 8 through the mediation of an Internet 6 and including a monitoring system 10 and an entry recovering system 12 along with the recording system 8 to monitor entry contents on a web page entered from the user terminal 4 and recover the entry contents lost from the user terminal 4. In the case of this embodiment, the recording system 8 is also used as a web server and this web server is a web page providing means. The web system 2A performs (1) display of a web page, (2) entry to the web page (entry to information entry fields), (3) sequential transmission of entry contents, (4) sequential recording of transmission contents, (5) detection of occurrence of page reload, (6) request for past entry contents, and (7) recovery of the past entry contents to recover the entry contents lost from the user terminal 4.

The user terminal 4 is an information processing apparatus connected to the network, makes up an information input means that displays a web page to enter information into an information input field thereof and to display information such as recovered entry contents, and makes up an instructing means that gives an instruction of page reload for lost entry contents. The user terminal 4 is made up of, for example, a personal computer (PC) having a communication function and is connected to the recording system 8 through the Internet 6. A displaying unit 14 of the user terminal 4 displays a web page provided from the recording system 8 and necessary information is entered into the web page from an input unit 16. If the entry contents are lost, an instruction of page reload is input from the user terminal 4. The entry contents on the web page are sequentially transmitted to the recording system 8 through the communication function of the user terminal 4, and the monitoring system 10 monitors the entry contents and the transmission contents. The instruction of page reload for the lost entry contents is monitored by the monitoring system 10 and transferred to the entry recovering system 12.

The Internet 6 is an example of a computer network and makes up a system for sharing information over a network. Although the Internet 6 is exemplarily illustrated in this embodiment, the network may be a network system consisting of a plurality of computers, for example, Ethernet (registered trademark).

The recording system 8 is a storage means (storage unit) that has entry contents recorded and stored thereon, is made up of a computer system connected to the Internet 6, is also used as a web server, and sequentially records the transmission contents transmitted from the monitoring system 10. The recording system 8 includes a server 18 and a data recording unit 20; the server 18 is a computer having a communication function; and the data recording unit 20 has a database (DB) or data file for storing the entry contents. The recording system 8 may be implemented by a processing function for the recording into DB through a response servlet (or cgi) of “Ajax” in the web server.

The monitoring system 10 is a monitoring means (monitoring unit) that monitors the entry contents of the user terminal 4, is software contained in the web page in this embodiment, and is a transmitting means that sequentially transmits the entry contents to the recording system 8 while monitoring the entry contents. Although the entry contents of the user terminal 4 are pieces of information entered into the user terminal 4 in this case and pieces of information written into a page are the entry contents in the case of a web page, the entry contents are not limited to pieces of entry information through the input unit 16 from a user 22. The monitoring system 10 may be implemented by an entry contents transmission function through JavaScript (Ajax) embedded in the web page.

The entry recovering system 12 is an entry recovering means (entry recovering unit) for the entry contents lost from the entry side, is software contained in the web page, executes detection of occurrence of page reload through the monitoring system 10, makes a request for past entry contents to the recording system 8, and executes recovery of the past entry contents in accordance with the provision from the recording system 8. In this embodiment, the entry recovering system 12 is also used as the monitoring system 10 in this embodiment. The entry recovering system 12 may be implemented using JavaScript (Ajax) embedded in the web page, for example.

With such a configuration, the monitoring system 10 monitors entry contents on an “entry form” of a web page deployed on the displaying unit 14 of the user terminal 4, and the entry contents are transmitted in real time to the recording system 8 that is a particular server. The server 18 of the recording system 8 receives the transmission contents from the monitoring system 10, and the transmission contents are recorded and stored in the data recording unit 20 in real time. In the case that the entry contents are lost from the user terminal 4, when a reload instruction is activated from the user terminal 4, the monitoring system 10 detects the occurrence thereof, which triggers a request for the entry contents to be issued. This request causes the entry recovering system 12 to acquire a recorded content list for the recorded contents of the recording system 8. As a result, arbitrary storage contents are read from the recording system 8, and the entry contents lost from the user terminal 4 are recovered on the displaying unit of the user terminal 4.

In the web system 2A above, the Ajax technology may be utilized for the monitoring system 10 and the entry recovering system 12.

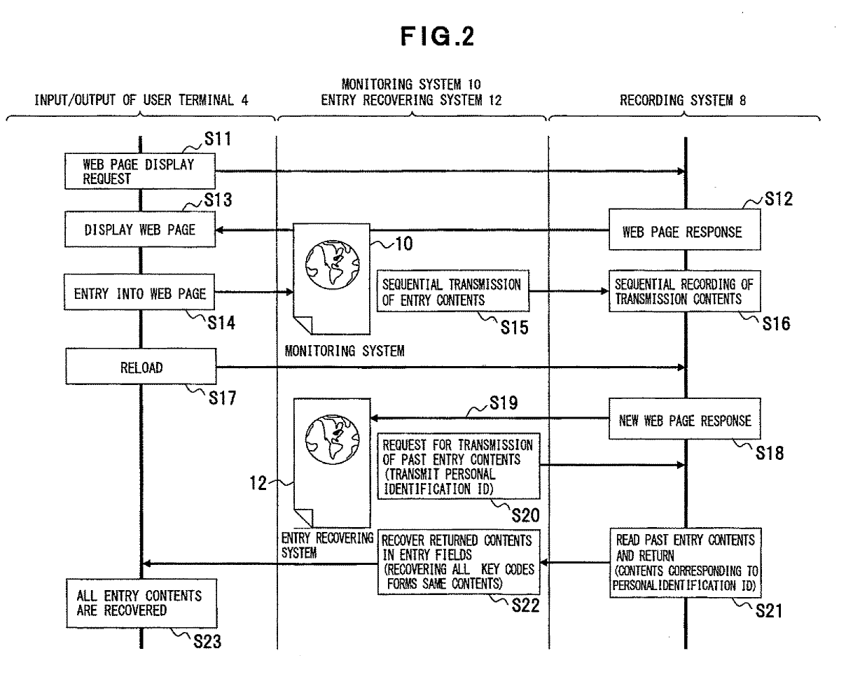

Input/output, storage, and recovery in the web system will then be described with reference to FIG. 2. FIG. 2 is a diagram of a process sequence of an input/output and recovery process of the web system. The configuration depicted in FIG. 2 is by way of example and the present invention is not limited to this configuration.

This process sequence is an example of an entry information recovering method or recovering program and is a process procedure representing processes and relationship of the input/output of the user terminal 4, the recording system 8, the monitoring system 10, and the entry recovering system 12.

The user terminal 4 outputs a web page display request (step S11), and when the web page display request arrives at the recording system 8, a web page response is executed by the recording system 8, which is also used as a web server acting as a web page providing means (step S12). The web page output from the recording system 8 arrives at the monitoring system 10 and the web page is displayed on the displaying unit 14 of the user terminal 4 (step S13).

When the user makes an entry into the web page through the input unit 16 of the user terminal (step S14), the entry contents of the web page are monitored by the monitoring system 10 and sequentially transmitted from the monitoring system 10 to the recording system 8 (step S15). The recording system 8 sequentially records and stores the transmission contents (step S16). With regard to the sequential recording of the transmission contents, the transmission contents include identification ID and entry key codes as identification information. The identification ID is unique ID utilized for uniquely identifying each entry when the entry contents of a plurality of entry fields are recorded in the recording system 8 for one or a plurality of persons, such as a membership number identifying the user 22 and a MAC (media access control) address identifying the user terminal 4. The input key code is an item for recording contents entered into a corresponding entry field.

If reload occurs in the user terminal 4 (step S17) due to erroneous operation, etc., the recording system 8 is notified of the reload. The reload corresponds to a request for reload, i.e., redisplay of the web page. When this request is accepted, a new web page response is executed by the recording system 8, which is also used as the web server (step S18). The new web page is a newly provided web page different from the web page response at step S12.

The entry recovering system 12 is notified of the new web page response (step S19), and the notified entry recovering system 12 issues a request for transmission of past entry contents to the recording system 8 (step S20). In this case, the personal identification ID is transmitted. As a result, the past entry contents are read from the recording system 8 and returned to the entry recovering system 12 (step S21). In this case, the transmission contents are those corresponding to the personal identification ID.

The entry recovering system 12 recovers the contents returned from the recording system 8 in the entry fields of the web page (step S22). In this case, the same contents are formed by recovering all the key codes. As a result, the entry contents on the web page are recovered and displayed on the displaying unit 14 of the user terminal 4 (step S23). In this case, the entry contents may be recovered on the old web page or the entry contents may be recovered on the new web page.

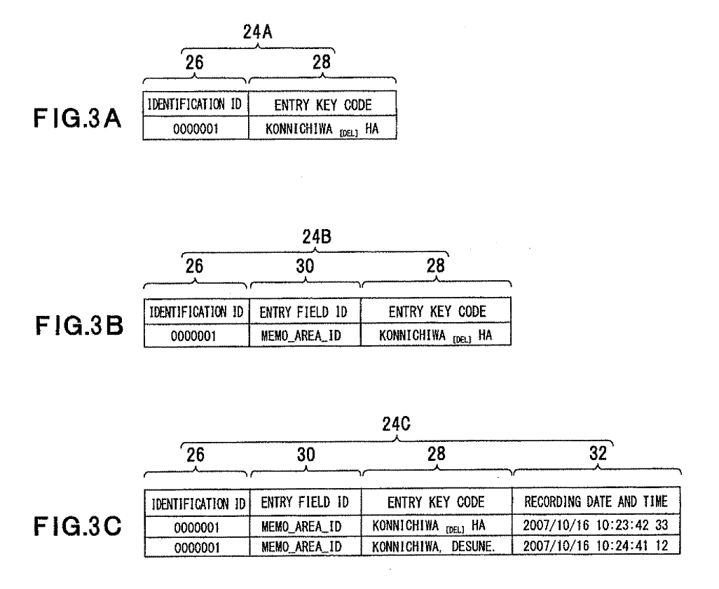

Recorded data configurations of entry contents will then be described with reference to FIGS. 3A to 3C. FIGS. 3A to 3C are diagrams of data tables having entry contents stored thereon. The configurations depicted in FIGS. 3A to 3C are by way of example and the present invention is not limited to these configurations.

For the data configuration in the data table having entry contents stored thereon, for example, a data configuration 24A (FIG. 3A) is established as a simple basic configuration to record the entry contents. This data configuration 24A includes identification ID 26 and an entry key code 28 as depicted in FIG. 3A. Since the identification ID 26 is unique ID utilized for uniquely identifying each entry when the entry contents of a plurality of entry fields are recorded in the recording system 8 for one or a plurality of persons, for example, in the case of a system utilized by a plurality of performs, ID such as a membership number may be recorded, or JSESSION ID in the case of a Java server may be recorded and a MAC address capable of uniquely identifying a device may be recorded. If the web system 2A is operated in a signal system, the identification ID for personal identification is not necessary.

Since the input key code 28 is an item for recording contents entered in a corresponding entry field, a key code given to an entered key is recorded word for word. In such a case that the burden of the system is high, it is contemplated that the monitoring system 10 includes a timer function, etc., and operated such that the timer function is used to import and transmit the entry contents periodically at arbitrary intervals such as “once a second” and, in this case, the latest entry contents at the time are recorded.

Recording the key code word for word means that all the operations may be recorded such as cursor motion and insertion/deletion and that the entry contents may more completely be recovered while the entry recovering system 12 is operated. If this level of accuracy is not required for the system, the entry contents may be imported periodically (or at any arbitrary time) as above.

If a web page includes a plurality of entry fields, a data configuration 24B (FIG. 3B) may be used. Although the data configuration 24A may be used in the case of a single entry field, the present invention is applicable to a plurality of entry fields. As depicted in FIG. 3B, the data configuration 24B is expanded by an item such as an entry field ID 30 in addition to the identification ID 26. The date of these items may simply be recorded by “always overwriting with the latest information”.

A data configuration 24C (FIG. 3C) capable of entry history management may also be used. This data configuration 24C includes recording date and time 32 in addition to the recording information as depicted in FIG. 3C, and the entry history may be managed with the use of the recording date and time 32. The recording date and time 32 may also be utilized in such case of going back to the point of the past entry to recover the entry contents.

The data format of the entry key code 28 may be a character string or binary data. In the case of the binary data, character codes may be included to recover the entry contents more accurately in some cases.

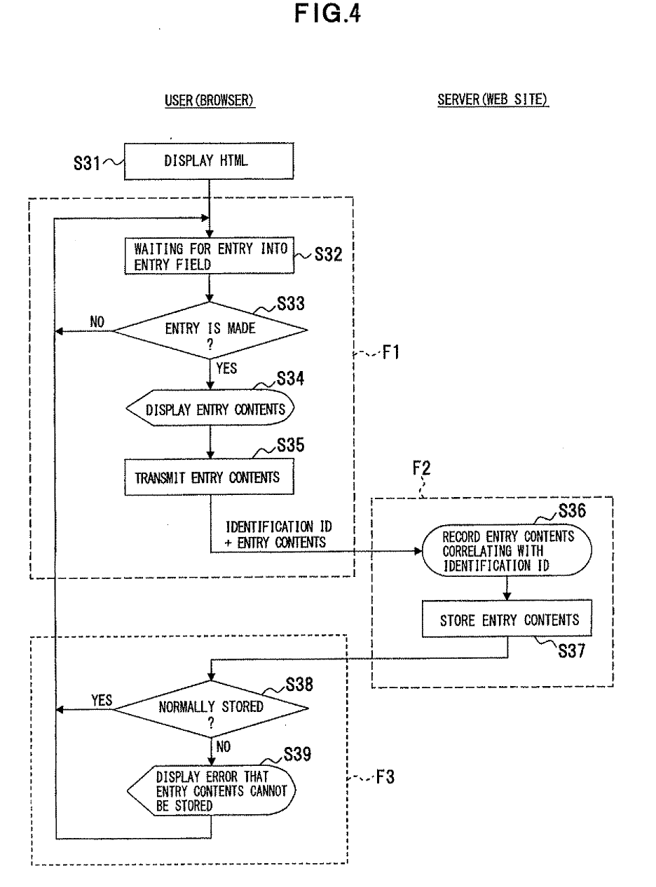

The monitoring and recording of the entry contents will then be described with reference to FIG. 4. FIG. 4 is a flowchart of an entry content monitoring and recording process procedure. The configuration depicted in FIG. 4 is by way of example and the present invention is not limited to this configuration.

This process procedure is an example of the entry information recovering method and recovering program, and includes processes of displaying on the user terminal 4 (step S31), a function F1 of the monitoring system 10 (steps S32 to S35), a function F2 of the recording system 8 (steps S36 and S37), and an entry content check function F3 (steps S38 to S39), and these user terminal entry content recovery processes are implemented by a browser process of the user terminal 4 and a process on the web site of the server 18 (FIG. 1) of the recording system 8. The function F1 of the monitoring system 10 is a function of sequentially detecting the entry contents with the use of a monitoring function (e.g., event handler) to transmit the entry contents to the recording system 8. The function F2 of the recording system 8 is a function of correlating and recording/storing the entry contents transmitted from the monitoring system 10 with identification information, for example, the identification ID for recording/storing. The entry content check function F3 is a processing function of checking whether the entry contents are normally stored.

In this process procedure, the user terminal 4 is activated and driven to display html (web page) (step S31) Although html is a language for describing hypertext, the html represents a web page in this case. The function F1 of the monitoring system 10 is executed through the display of html, and after waiting for entry into the entry field (step S32), it is determined whether an entry is made into the entry field (step S33), and if an entry is not made (NO at step S33), the entry waiting state of step S32 is maintained. If an entry is made (YES at step S33), the entry contents are displayed (step S34) and the entry contents are transmitted (step S35).

When the entry contents are transmitted, the identification ID and the entry contents are transmitted to the recording system 8, and the recording system 8 correlates the entry contents with the identification ID to record the entry contents (step S36) and stores the entry contents (step S37).

The check function F3 is executed for the storage of the entry contents. It is determined whether the entry contents are normally stored (step S38); if the entry contents are normally stored (YES at step S38), the procedure goes back to step S32; and if the entry contents are not normally stored (NO at step S38), an alert is issued by displaying that an error occurs because the entry contents cannot be stored (step S39).

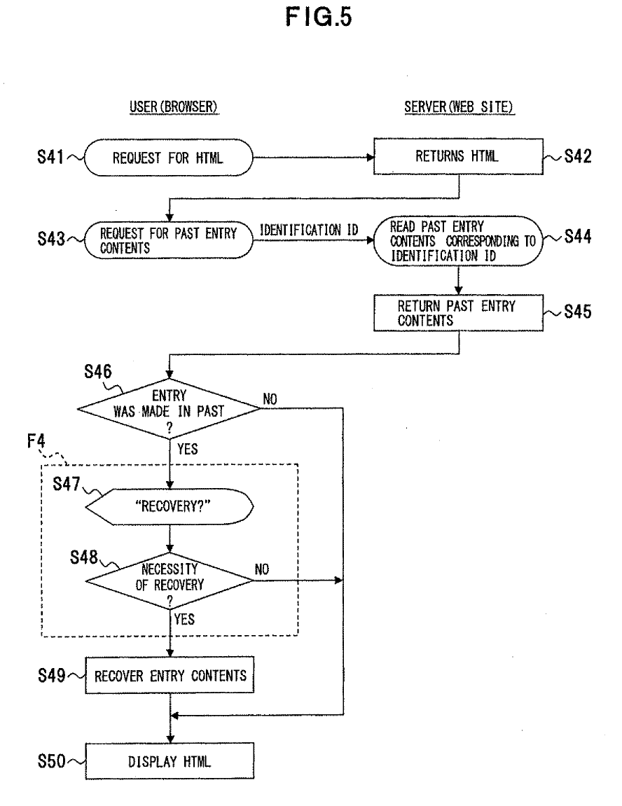

The web page display will then be described with reference to FIG. 5. FIG. 5 is a flowchart of a web page display process procedure. The configuration depicted in FIG. 5 is by way of example and the present invention is not limited to this configuration.

The web page display process procedure is an example of the entry information recovering method and recovering program and the entry contents recovery process of the user terminal 4 is implemented by a browser process of the user terminal 4 and a process on the web site of the server 18 (FIG. 1) of the recording system 8. This process procedure includes a process of a function F4 of selecting whether the entry content may be recovered (steps S47 and S48).

In this process procedure, as depicted in FIG. 5, the browser of the user terminal 4 issues a request for html to the web site of the server 18 (step S41) and the server 18 accepting the request for html returns html to the user terminal 4 (step S42). The user terminal 4 issues a request for past entry contents (step S43) and this request for past entry contents is transmitted to the server 18 along with the identification ID, and the server 18 accepting this request reads the past entry contents corresponding to the identification ID (step S44) and executes a process of returning the past entry contents (step S45).

The browser of the user terminal 4 having the entry contents returned determines whether an entry was made in the past (step S46), and if an entry was made in the past (YES at step S46), for example, “recovery?” is displayed for an inquiry of necessity of the entry content recovery (step S47) to determine the necessity of the recovery (step S48). If recovered (YES at step S48), the entry contents are recovered (step S49) to display the html (step S50). In this case, if no entry was made in the past (NO at step S46) or if the entry contents are not recovered (NO at step S48), the procedure also goes to step S50 to display the html.

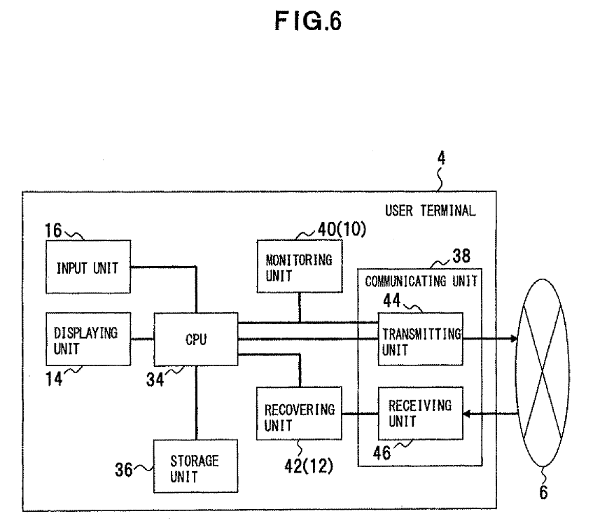

An example of the user terminal will then be described with reference to FIG. 6. FIG. 6 is a diagram of a basic configuration of the user terminal. The configuration depicted in FIG. 6 is by way of example and the present invention is not limited to this configuration. In FIG. 6, the same reference numerals are added to the same portions as FIG. 1.

The user terminal 4 is a computer connected through the Internet 6 to the server 18 acting as the web server making up the recording system 8 and is a means of executing the browser as well as a means of executing the entry information recovering method and program.

The user terminal 4 includes the displaying unit 14 and the input unit 16 above and includes a CPU (central processing unit) 34, a storage unit 36, a communicating unit 38, a monitoring unit 40, and a recovering unit 42.

The CPU 34 is an example of a means of executing OS (operating system) and application programs in the storage unit 36, the browser, and the entry information recovering method and program, and performs the import of the entry information from the input unit 16, the display of the web page with the browser, the writing into the web page, the recording control for various pieces of information, the data transmission/reception control, etc.

The storage unit 36 is a storage means for various programs such as the OS and the application programs as well as a recording means for various pieces of information, is made up of a recording device, and includes a program storage unit, a data storage unit, a RAM (random access memory), etc. The program storage unit has various programs such as OS and application programs stored thereon; the data storage unit has various pieces of information stored thereon and has a database established thereon; and the RAM is used as a work area.

The communicating unit 38 is a means of importing a web page from the network and transmitting entry information such as the above described entry contents under the control of the CPU 34 and includes a transmitting unit 44 that transmits information and a receiving unit 46 that receives information. The transmitting unit 44 is an information transmitting means and the receiving unit 46 is an information receiving means.

The monitoring unit 40 is an example of the above described monitoring system 10 and executes the entry information recovering program. Although the monitoring unit 40 is made up of a RAM, the monitoring unit 40 may be made up of hardware. The monitoring unit 40 may include a timing function correspondingly to the monitoring system 10 including a timer function to execute the data monitoring function at predetermined time intervals.

The recovering unit 42 is an example of the above entry recovering system 12 and executes the entry information recovering program. Although the recovering unit 42 is made up of a RAM, the recovering unit 42 may be made up of hardware.

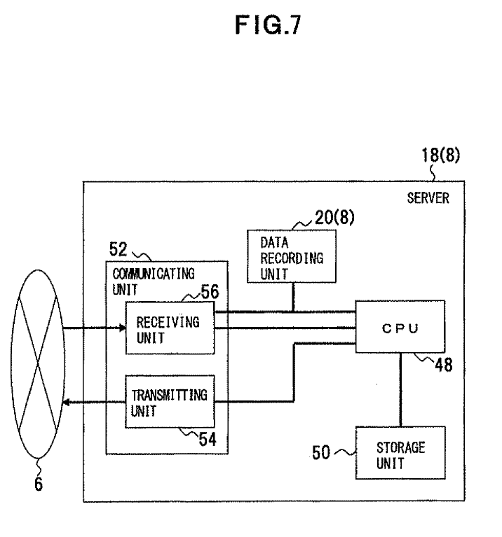

The server will then be described with reference to FIG. 7. FIG. 7 is a diagram of a basic configuration of the server. The configuration depicted in FIG. 7 is by way of example and the present invention is not limited to this configuration. In FIG. 7, the same reference numerals are added to the same portions as FIG. 1.

The server 18 makes up the recording system 8 together with the data recording unit 20, makes up the web server and the web site, and is a web page providing means. The server 18 includes a CPU 48, a storage unit 50, and a communicating unit 52.

The CPU 48 is an example of a means of executing OS and application programs in the storage unit 50 and the entry information recovering method and program, and performs the provision of the web page, the recording control of the contents entered into the web page on the browser, the transmission control based on the request for the entry contents recorded in the data recording unit 20, the transmission/reception control for various data, etc.

The storage unit 50 is a storage means for various programs such as the OS and the application programs as well as a recording means for various pieces of information, is made up of a recording device, and includes a program storage unit, a data storage unit, a RAM, etc. The program storage unit has various programs such as OS and application programs stored thereon; the data storage unit has various pieces of information stored thereon; and the RAM is used as a work area.

The communicating unit 52 is a means of providing a web page from the network, receiving entry information such as the above described entry contents, and performing the transmission based on the request for the entry contents recorded on the data recording unit 20 under the control of the CPU 48, and includes a transmitting unit 54 acting as a transmitting means that transmits information and a receiving unit 56 acting as a receiving means that receives information.

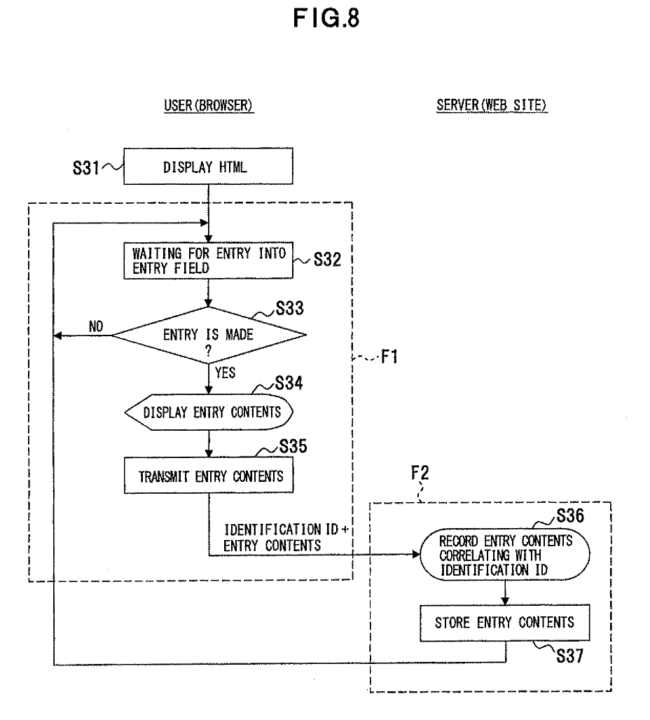

Although the process is executed through the entry content check function F3 (steps S38 to S39) in the flowchart depicted in FIG. 4 in this embodiment, the procedure may go back to step S32 after the function F2 as depicted in FIG. 8.

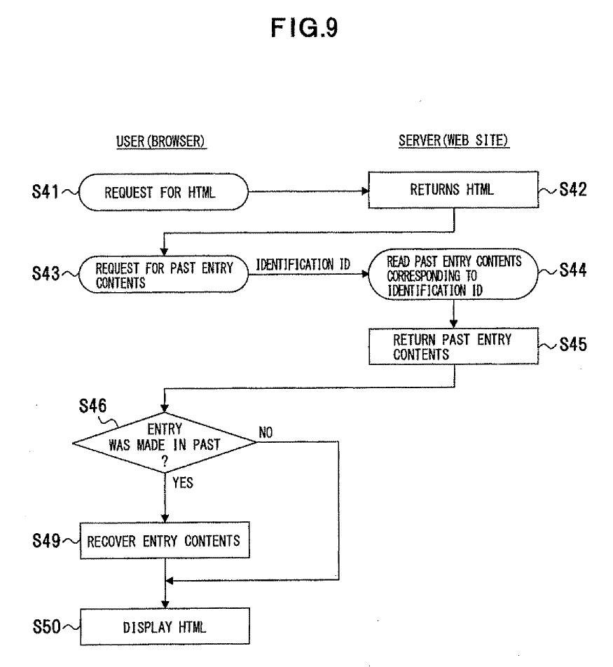

Although the process is executed through the function F4 of selecting whether the entry content may be recovered (steps S47 and S48) in the flowchart depicted in FIG. 5, if it is determined that the entry was made in the past at step S46, the procedure may jump to step S49 to recover the entry contents as depicted in FIG. 9.

Features, advantages, or modifications of the first embodiment described above will be listed as follows.

(1) Since the entry contents lost from the user terminal 4 may be recovered, a long text entry on the browser may rapidly be recovered, and opportunities to provide services such as web pages may be expanded without forcing the time loss due to the reentry to user to expand the commercial transaction through the network.

(2) If entry contents are lost from the user terminal 4, the entry contents before the loss may automatically be recovered and, therefore, worries about loss of entry contents may be eliminated.

(3) When entering a long text into a web page, associated efforts using telephone or FAX for avoiding the loss of the entry contents may be avoided to accelerate the information process and reduce the cost of support using telephone or FAX, the personnel cost, etc.

(4) Since the entry contents are sequentially recorded and stored in the recording system 8, the user's entry contents may be checked in real time and the administrator may rapidly identify or comprehend problems, etc., that the user faces and may contribute to the realization of the service expected by the user.

(5) The entry contents recorded in the recording system 8 may be recovered on another web page. The past entry contents may be entered into another web page in the form of recovery, and the same entry contents may be utilized in such way that transmitting to a multiplicity of destinations.

(6) The recording system 8 may not necessarily be disposed on a remote server over the Internet 6 and may be implemented as an application on a local PC, and the entry contents may be recovered with reduced security risk due to leaving the entry contents on the Internet.

(7) The monitoring system 10 may be implemented to monitor not only the entry contents but also mouse operations, for example. In this case, for example, in such a case that the OS is forcible terminated, the entry recovering system 12 may be activated after reboot and the entry contents may be recovered by reproducing all the procedures immediately before the OS is forcible terminated.

(8) Since the entry recovering system 12 may recover the recorded entry contents any number of times, the entry contents may repeatedly modified and utilized. For example, if a tag for recovering the entry contents is set in the recording system 8, the entry contents may be recovered to the point of the tag, which may be utilized in the situation of managing edit histories.

### [b] Second Embodiment

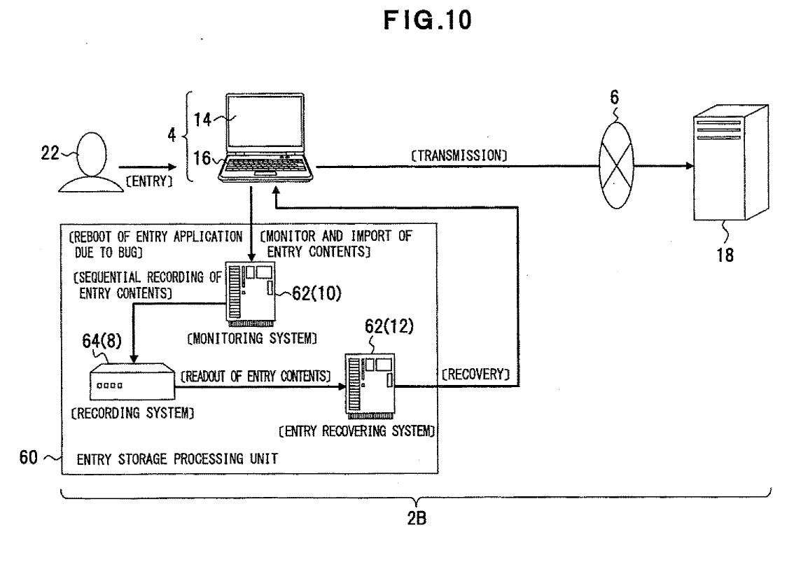

A second embodiment will be described with reference to FIG. 10. FIG. 10 is a diagram of a web system according to the second embodiment. The configuration depicted in FIG. 10 is by way of example and the present invention is not limited to this configuration. In FIG. 10, the same reference numerals are added to the same portions as FIG. 1.

Although the web system 2A of the first embodiment is a system disposed with the recording system 8 also used as the web server to store the entry contents through the Internet 6, the recording system 8 is established on the user terminal 4 side to make up a local system that stores the entry contents in a web system 2B (FIG. 10) in this embodiment. It is advantageous to store the entry contents in such a local system in the light of security.

As depicted in FIG. 10, the web system 2B includes the user terminal 4 connected to the server 18 through the mediation of an Internet 6, and an entry storage processing unit 60 is disposed on the user terminal 4 side. The user terminal 4 may acquire a web page provided from the web site (server 18) on the Internet 6 and display the web page on the displaying unit 14 to enter information into the web page through the input portion 16.

The entry storage processing unit 60 is a system that monitors the entry contents from the user terminal 4 into the web page to store the entry contents and to recover the entry contents lost from the user terminal 4, and includes a server 62 and a date recording unit 64.

The server 62 is a computer making up the monitoring system 10 and the entry recovering system 12. The monitoring system 10 is a means of monitoring the entry contents of the user terminal 4 and importing the entry contents as described above. The entry recovering system 12 is a means of reading the entry contents in the date recording unit 64 for recovery on the user terminal 4.

The data recording unit 64 makes up the recording system 8 and is a data storage means that has the entry contents stored thereon. The entry contents imported into the server 62 are sequentially recorded into the date recording unit 64.

The web system 2B performs (1) entry to the web page, (2) monitor and import of entry contents, (3) sequential recording of the entry contents, (4) for example, reboot of an entry application due to bug, which triggers the recovery of the entry contents, (5) readout of the entry contents, (6) recovery of the entry contents, and (7) transmission of the entry contents to recover the entry contents lost from the user terminal 4.

With such a configuration, the monitoring system 10 monitors entry contents on an “entry form” of a web page deployed on the displaying unit 14 of the user terminal 4, and the entry contents are imported into the server 62 in real time and sequentially recorded and stored in the data recording unit 64 of the recording system 8. In the case that the entry contents are lost from the user terminal 4, when a reload instruction is activated from the user terminal 4, the entry recovering system 12 detects the occurrence thereof, which triggers a request for the entry contents to be issued. This request causes the entry recovering system 12 to acquire a recorded content list for the recorded contents of the recording system 8. As a result, the entry contents are read from the recording system 8, and the entry contents lost from the user terminal 4 are recovered on the the user terminal 4.

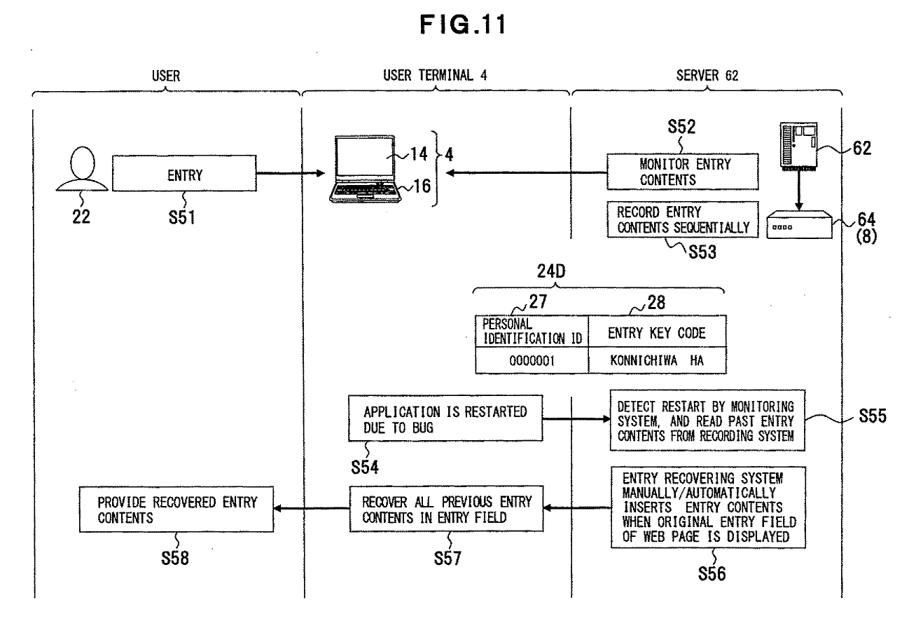

The entry contents storing process will then be described with reference to FIG. 11. FIG. 11 is a diagram of a process sequence of the entry content storing process. The configuration depicted in FIG. 11 is by way of example and the present invention is not limited to this configuration.

This process sequence is an example of the entry information recovering method or recovering program and is a process procedure representing the input/output of the user terminal 4 by the user 22, the monitoring and storing thereof, and the recovery at the time of loss of entry contents, and the relationship thereof.

A web page is acquired by the user terminal 4 and the user 22 enters necessary information into an entry field of the web page. The user terminal 4 accepts the entry from the input unit 16 (step S51). The entry contents into the entry field of the web page are monitored (step S52) and the entry contents are sequentially recorded and stored in the data recording unit 64 (step S53). In this case, a data configuration 24D of the entry contents includes a personal identification ID 27 and an entry key code 28 as depicted in FIG. 11. The personal identification ID 27 corresponds to the identification ID 26 (FIG. 3A) of the data configuration 24A and is identification information (unique ID such as a MAC address) for personally identifying the user 22, and the entry key code 28 is the directly recorded data (including entry errors) of the entered key code values. With such a process, all the entry contents into the user terminal 4 are monitored through the operations of the user 22, and recorded and stored in the data recording unit 64. The stored entry contents may be read out by specifying the personal identification ID 27.

If the application is restarted in the user terminal 4 due to, for example, a bug (step S54), the above described entry contents are lost. This restart is detected by the monitoring system 10 and the past entry contents are read (imported) from the data recording unit 64 of the recording system 8 (step S55). The read entry contents are delivered to the entry recovering system 12 and when the original entry field of the web page is displayed, the entry recovering system 12 manually/automatically inserts the entry contents into the entry field (step S56). As a result, all the previous entry contents are recovered in the entry field of the web page displayed on the displaying unit 14 of the user terminal 4 (step S57).

In this case, if the user 22 redisplays the entry field on the user terminal 4, the recovered entry contents are provided without any change from the original entry (step S58) and the entry contents may be used.

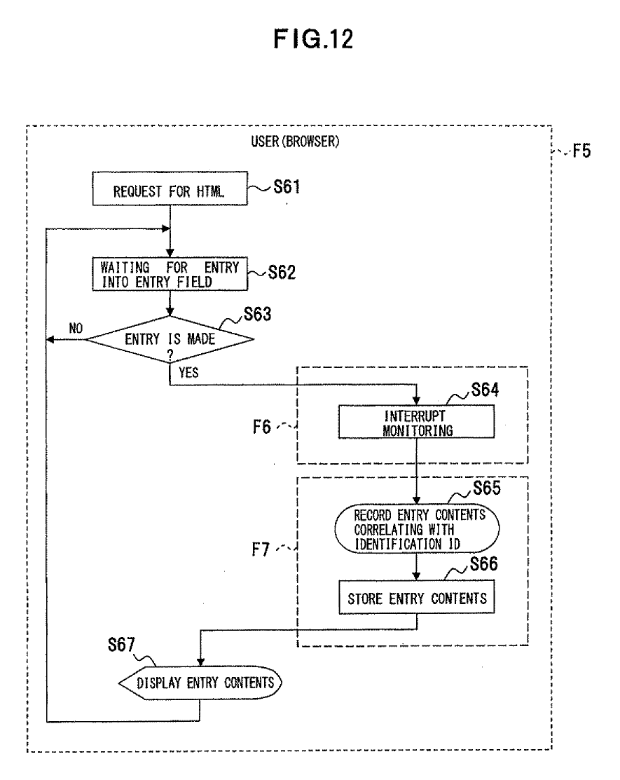

The monitoring and recording of the entry contents will then be described with reference to FIG. 12. FIG. 12 is a flowchart of an entry content monitoring and recording process procedure. The configuration depicted in FIG. 12 is by way of example and the present invention is not limited to this configuration.

This process procedure is an example of the entry information recovering method and program, is a process of automatically implementing the monitoring and recording of the entry contents in a local system on the user terminal 4 side, and is executed by functions on the user 22 side, i.e., the browser function of the user terminal 4 and a function F5 of the server 62 and the data recording unit 64, and the function F5 includes processes of a function F6 of the monitoring system 10 and a function F7 of the recording system 8. The function of the function F6 is a function of sequentially detecting the entry contents with the use of a monitoring function (e.g., event handler) to deliver the entry contents to the recording system 8, and the function F7 of the recording system 8 is a function of correlating the entry contents transmitted from the monitoring system 10 with identification information, for example, the identification ID for recording/storing.

In this process procedure, the user terminal 4 is activated to request display of the html (web page) (step S61) Although html is a language for describing hypertext, the html represents a web page in this case. When the html is displayed, the entry into the entry field thereof is waited (step S62), it is determined whether an entry is made into the entry field (step S63), and if an entry is not made (NO at step S63), the entry waiting state of step S62 is maintained. If an entry is made (YES at step S63), the process of the function F of the monitoring system 10 is executed to interrupt the monitoring (step S64). In this monitoring interruption process, the monitoring of the entry contents is executed to transmit the entry contents and the identification ID to the recording system 8.

With the function F7 of the recording system 8, the identification ID and the entry contents from the monitoring system 10 are received; the entry contents are recorded with correlated the identification ID (step S65); and the entry contents are stored (step S66). The entry contents are displayed on the user terminal 4 (step S67) and the procedure goes back to step S62. The entry contents from the user 22 are sequentially recorded in the data recording unit 64 and the entry contents may be checked from the display on the displaying unit 14.

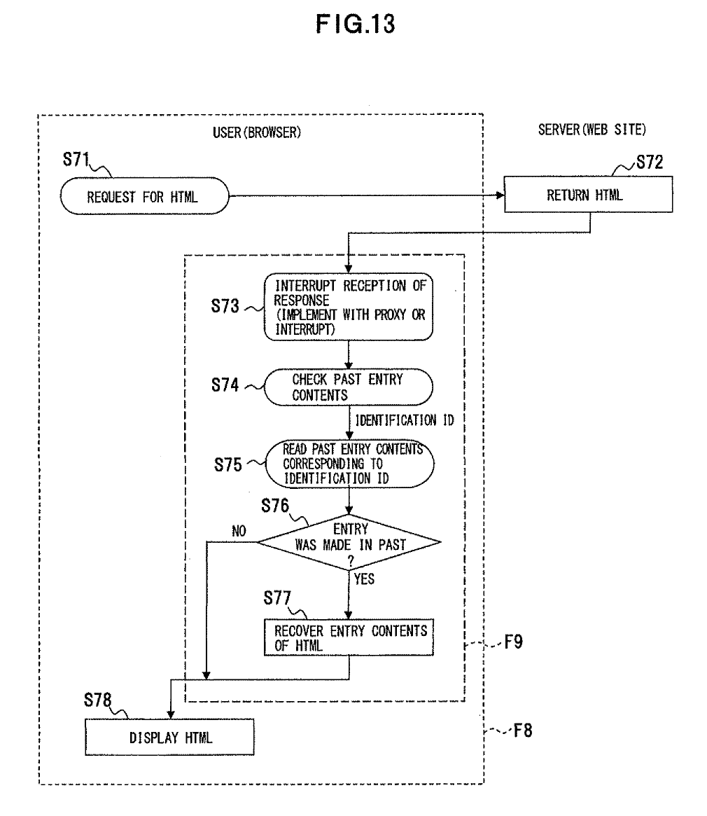

The recovery of the entry contents will then be described with reference to FIG. 13. FIG. 13 is a flowchart of a process procedure of the entry content recovering process. The configuration depicted in FIG. 13 is by way of example and the present invention is not limited to this configuration.

This process procedure is an example of the entry information recovering method and program and implements the entry content recovering process of the user terminal by the browser process of the user terminal 4 and the process of the data recording unit 64 of the recording system 8. In this process procedure, a function F8 of the user terminal 4 includes a process of a function F9 of the entry recovering system 12.

In this process procedure, as depicted in FIG. 13, the browser of the user terminal 4 issues a request for html to the web site of the server 18 (step S71) and the server 18 accepting the request for html returns html to the user terminal 4 (step S72). The reception of response for the user terminal 4 is interrupted (step S73); a request for check of past entry contents is issued (step S74); this request for past entry contents is transmitted to the server 62 along with the identification ID; the server 62 accepting this request reads the past entry contents corresponding to the identification ID (step S75); it is determined whether an entry was made in the past (step S76); if an entry was made in the past (YES at step S76), the entry contents of the html are recovered (step S77); the operation of the entry recovering system 12 is shifted to the normal display to execute the display of the html (step S78). If no entry was made in the past (NO at step S76), the procedure goes to step S78 to display the html.

In such an entry recovering process, the html request to the web server may be interrupted to inquire the presence of the past entry contents corresponding to the html, and the lost entry contents may be recovered and displayed by embedding the entry contents into the html as needed and returning the lost entry contents to the browser as if the contents are entered from the beginning.

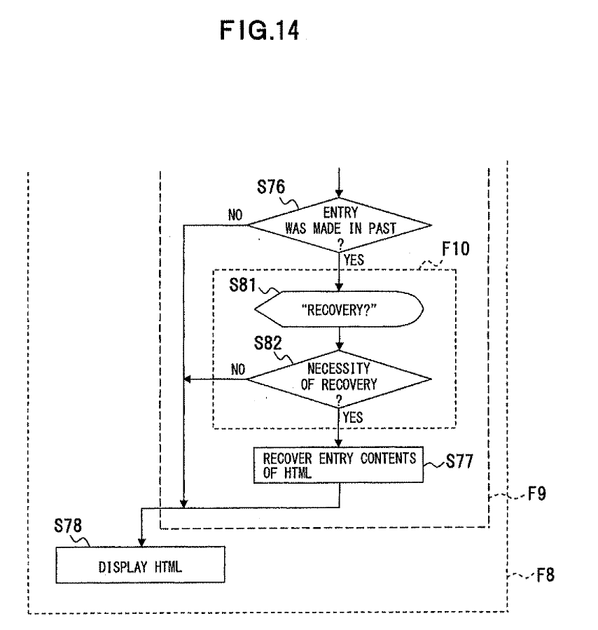

If it is allowed to select whether the recovery of the entry contents is performed in this case, a process of a selection function F10 is inserted as depicted in FIG. 14 to display an inquiry of whether the recovery is performed on the displaying unit 14 if it is determined that the entry was made in the past at step S76 (step S81); after the selection is made based on the display, it is determined whether the recovery is performed (step S82); if the recovery is performed (YES at step S82), the procedure goes to step S77 to recover the entry contents; and if the recovery is not performed, the html is displayed (step S78).

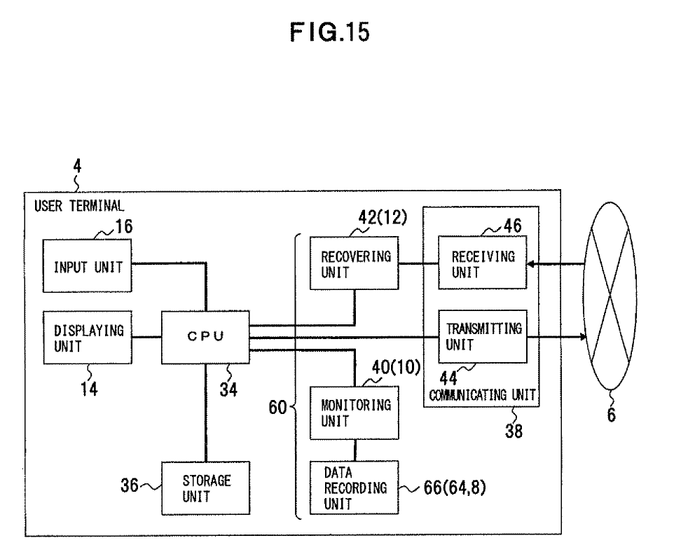

The user terminal will then be described with reference to FIG. 15. FIG. 15 is a diagram of a basic configuration of the user terminal. The configuration depicted in FIG. 15 is by way of example and the present invention is not limited to this configuration. In FIG. 15, the same reference numerals are added to the same portions as FIG. 6.

The user terminal 4 is a computer connected through the Internet 6 to the server 18 and is a means of executing the browser as well as a means of executing the entry information recovering method and program.

The user terminal 4 includes the described displaying unit 14 and input unit 16 and includes the CPU 34, the storage unit 36, the communicating unit 38, the monitoring unit 40, the recovering unit 42, and a data recording unit 66 and has the above described entry storage processing unit 60 built-in in this embodiment. The portions of each function unit same as the first embodiment are given the same reference numerals and will not be described.

The monitoring unit 40 is an example of the above described monitoring system 10 and executes the entry information recovering program. Although the monitoring unit 40 is made up of a RAM, the monitoring unit 40 may be made up of hardware. The monitoring unit 40 is connected to the data recording system 66, and this data recording system 66 makes up the recording system 8 along with the CPU 34 and the storage unit 36 and corresponds to the data recording unit 64 of the web system 2B depicted in FIG. 10. While the data recording unit 64 is disposed on the outside of the user terminal 4 of FIG. 10, the data recording unit 66 is disposed within the user terminal 4 to store the entry contents in this embodiment.

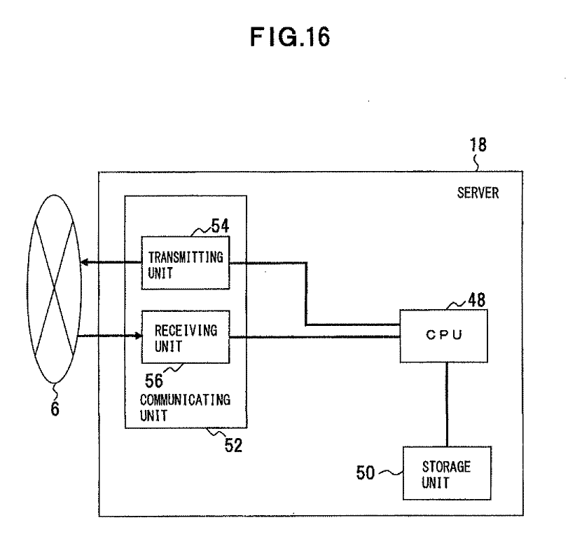

The server 18 will then be described with reference to FIG. 16. Since the recording system 8 is established on the user terminal 4, it is not necessary to dispose the data recording unit 20 in the server 18, so the data recording unit 20 (FIG. 7) is removed from the server 18. Since other constituent elements are the same as the first embodiment, these elements are given the same reference numerals and will not be described.

### EXAMPLE

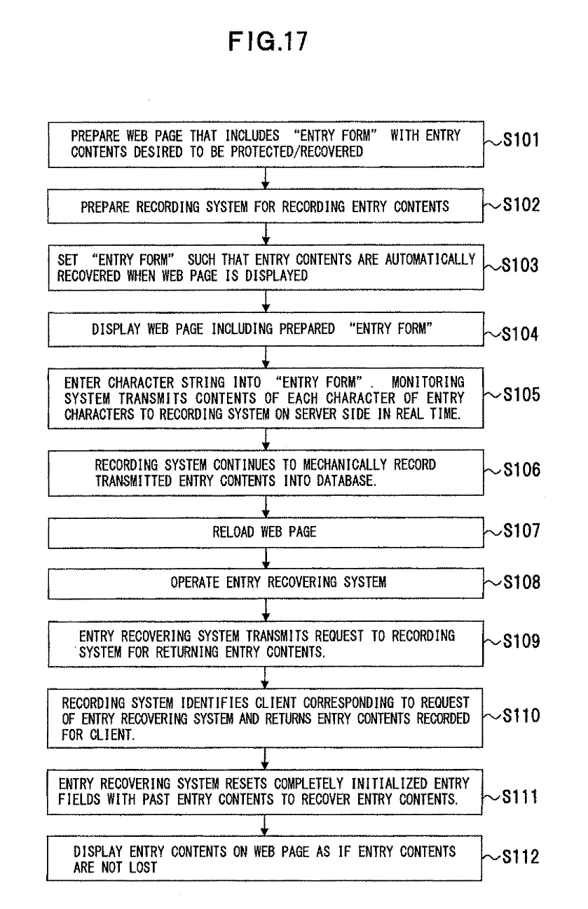

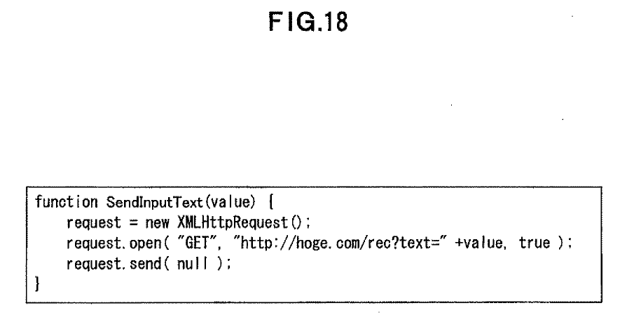

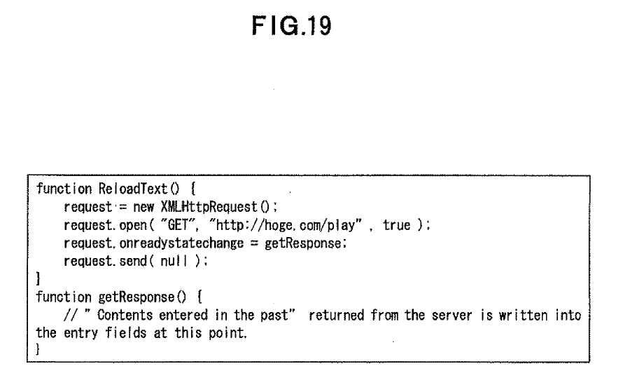

The example of the present invention will be described with reference to FIGS. 17, 18, and 19. FIG. 17 is a flowchart of process procedure of monitoring, storing, and recovering entry content of a web page; FIG. 18 is a diagram of transmission contents to the recording system; and FIG. 19 is a diagram of request contents for recovering the entry contents. The configurations depicted in FIGS. 17 to 19 are by way of example and the present invention is not limited to these configurations.

This example corresponds to the first embodiment and includes the monitoring system 10, the recording system 8, and the entry recovering system 12 for entries into web pages.

a) The monitoring system 10 monitors entry contents into an “entry form” on the web page and transmits the contents to the particular server 18 (FIG. 1) in real time. The monitoring system 10 is contained in the web page including the “entry form”. The web page may be implemented with the event handler of JavaScript, for example.

b) The recording system 8 includes the server 18, is a recording/storage system that receives the entry contents of a) to record/store the contents in real time, and mechanically and sequentially records the transmitted contents on the web server into the database. The recording system 8 may be implemented by a servlet (program on the web server using Java).

c) The entry recovering system 12 is a means of acquiring a list of contents recorded/stored in the server 18 (FIG. 1) and the data recording unit 20 and reading arbitrary storage contents to recover the entry contents and may be contained as a portion of the function of the monitoring system 10. The recovery function may be simplified and implemented by, for example, the event handler of JavaScript such that the entry contents are recovered (when a web page is newly displayed).

The entry content monitoring, storing, and recovering process procedure will be described with reference to a flowchart depicted in FIG. 17.

First, for an “entry form”, a web page is prepared that includes an “entry form” with entry contents desired to be protected/recovered (step S101). The monitoring system 10 is implemented in this web page. In this case, for example, a tag such as <textarea> is used to create the “entry form” of character strings in html. An event handler called onkeyup=“ ” is set so as to detect the entry contents in real time. For example, the event handler may be set by giving a description of <textarea onkeyup=“SendInputText(value)”> such that the SendInputText( ) function of JavaScript is called each time a key is pushed and released. The SendInputText( ) function is set such that the entry contents are sequentially recorded in the recording system 8. By way of example, if a known technology called Ajax is used for the transmission, the function may be described as below.

For the monitoring system 10, the recording system 8 is prepared for recording the entry contents (step S102). For example, if a program on the server 18 using Java is used, a Java servlet is generated. The Java servlet overrides doGet( ) and doPost( ) methods and mechanically records a character string XXXX of “text=XXXX” transmitted from the monitoring system 10 into a database, for example. In this case, information is also recorded that is indicative of which client the recoded contents are transmitted from, etc.

The recorded data configuration is configured as follows (FIG. 18).

```
      function SendInputText(value){
        request = new XMLHttpRequest( );
        request.open(“GET”, “http://hoge.com/rec?text=”
+value, true);
        request.send(null);
      }
```

For the entry recovering system 12, the “entry form” is set such that the entry contents are automatically recovered when the web page is displayed (step S103). The event handler is prepared.

The event handler is set for the case of displaying the created web page and, specifically, for example, a description of <body onload=“ReloadText( )”> may be given to set such that the ReloadText( ) function of JavaScript is automatically called when this html is displayed.

In ReloadText( ), transmission of a request is set as a notification request for the past entry contents to the server 18 to recover the entry contents of the web page. By way of example, if the known technology called Ajax is used for the request, the description is given as follows (FIG. 19).

```
      function ReloadText( ){
        request = new XMLHttpRequest( );
        request.open(“GET”, “http://hoge.com/play”, true);
        request.onreadystatechange = getResponse;
        request.send(null);
      //”contents entered in the past” returned from the
server is written into the entry fields at this point
      }
```

The web page including the prepared “entry form” is then displayed (step S104). A character string is entered into the “entry form”. The monitoring system 10 transmits contents of the entry characters to the recording system 8 on the server 18 side in real time (step S105).

The recording system 8 continues to mechanically record the transmitted entry contents into the database as described above (step S106). In this case, Identification information is also recorded that is indicative of which client the contents are transmitted from, etc., and the contents may be recorded on a destination other than the database, such as a file or memory.

It is assumed here that the web page is “reloaded” (step S107). Since the entry contents are recovered due to the function of the browser when a cache operates, the “reload” is executed after the cache is deleted. The server 18 newly transmits a request for retransmission of the web page including the “entry form”.

When the web page is newly transmitted from the server 18, the web browser determines that “the new web page is displayed” and discards the previous contents of the cache for display as the new web page. Therefore, the relevance with the past entry contents are lost and the web browser displays all the entry fields in the completely initialized state. As a result, all the current entry contents are lost.

In this example, the entry recovering system 12 starts operating (step S108). Since the entry recovering system 12 is activated when a web page is newly displayed, the entry recovering system 12 is activated when the web page is displayed as a new web page.

The entry recovering system 12 transmits a request to the recording system 8 for returning the entry contents (step S109). The recording system 8 uses the identification ID to identify a client corresponding to the request of the entry recovering system 12 and returns the entry contents recorded for the client (step S110).

The entry recovering system 12 resets the completely initialized entry fields with the past entry contents returned from the entry recovering system 12 to recover the entry contents (step S111). As a result, the entry contents are displayed on the web page as if the entry contents are not lost from the standpoint of the user (step S112).

Since the entry contents entered into the entry form on the web page are sequentially sent and recorded/stored in the recording system 8 as described above, if the entry contents are lost, the entry form on the web page may be recovered by the entry contents recorded in the recording system 8, and the entry contents are protected and reentry is not required.

The features and the advantages of the embodiments are listed as follows.

(1) If entry contents are lost from the displaying unit of the information processing apparatus, the entry contents may accurately be reproduced. Users are not forced to make a reentry.

(2) Since the entry contents are recorded and stored in a storage means, the entry contents may be checked in real time and the entry contents may rapidly be recovered if the entry contents are lost, resulting in more rapid information processing.

(3) If the storage means of the entry contents is provided on the information entry side, the lost entry contents may be recovered while ensuring the security of the entry contents.

The present invention relates to an information processing apparatus connected to a network to transmit/receive information and is useful because if entry contents are lost from a displaying unit of the information processing apparatus, the entry contents may accurately be reproduced without forcing reentry on a user, which contributes to more rapid information processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, connected to a network, which transmits and receives information, comprising:
an information entering unit that displays an information entry field provided from the network to make an entry into the information entry field;
an entry monitoring unit that monitors the entry into the information entry field, and that outputs entry contents of the information entry field along with at least identification information of the information entering unit;
a storage unit that correlates the entry contents output from the entry monitoring unit with the identification information to store the entry contents; and
an entry recovering unit that accepts a recovery instruction for the entry contents including the identification information from the information entering unit losing the entry contents, and that takes the entry contents in from the storage unit and recovers the entry contents on the information processing apparatus.

2. The information processing apparatus of claim 1, comprising
a displaying unit that displays the information entry field.

3. The information processing apparatus of claim 1, wherein
the entry monitoring unit sequentially transmits the entry to the storage unit in real time correspondingly to the entry into the information entry field.

4. The information processing apparatus of claim 1, wherein
the storage unit includes a data table that stores thereon recording date and time information along with the identification information and the entry contents.

5. The information processing apparatus of claim 1, wherein
the entry monitoring unit and the entry recovering unit are provided on the side of the information entry unit, and the information entry unit and the storage unit are connected through the network.

6. The information processing apparatus of claim 1, wherein
the storage unit is made up of a computer which includes a communication function and is connected to the network

7. An entry recovering method of an information processing apparatus, connected to a network, which transmits and receives information, comprising of:
displaying an information entry field provided from the network to make an entry into the information entry field;
monitoring the entry into the information entry field to output entry contents of the information entry field along with at least identification information of the entry;
correlating the entry contents with the identification information to store into a storage unit; and
accepting a recovery instruction for the entry contents including the identification information to take the entry contents in from the storage unit and recover the entry contents on the information processing apparatus when the entry contents are lost.

8. A computer-readable recording medium storing an entry recovering program of an information processing apparatus connected to a network to transmit and receive information, the program operable to drive the apparatus to function as:
an entry monitoring unit that displays an information entry field provided from the network, the entry monitoring unit monitoring the entry into the information entry field to output entry contents of the information entry field along with at least identification information of the entry;
a storage unit that stores the entry contents output from the entry monitoring unit, the storage unit correlating the entry contents with the identification information; and
an entry recovering unit that accepts a recovery instruction for the entry contents including the identification information to take the entry contents in from the storage unit and recover the entry contents on the information processing apparatus when the entry contents are lost.
